(19) United States
(12) Patent Application Publication
(10) Pub. No.: US 2006/0168719 A1
(43) Pub. Date: Aug. 3, 2006

(54) Portable sauna system

(76) Inventor: Jimmie W. Kirkland, Sun City West, AZ (US)

Correspondence Address: ROBERT A. PARSONS, 4000 N. CENTRAL AVENUE, SUITE 1220, PHOENIX, AZ, 85012, US

(21) Appl. No.: 11/226,101

(22) Filed: Sep. 14, 2005

Related U.S. Application Data
(60) Provisional application No. 60/649,315, filed on Feb. 2, 2005.

(51) Int. Cl. A61H 33/06

(52) U.S. Cl. 4/524

(57) ABSTRACT

A portable sauna system includes a portable sauna enclosure defining an enclosed body receiving interior volume and defining a head opening, two hand openings, and two foot openings. A divide, or entryway, extends from the head opening to a point spaced apart from the bottom end for entering a body into the enclosure. Opposing sides of the divide include a closure device, such as a zipper or buttons, to close the enclosure about a body. A hot air inlet is formed in the portable sauna enclosure and designed to receive a hot air outlet of a hot air supply for communicating hot air from the hot air supply to the body receiving interior volume. A hot air unit has a hot air outlet nozzle attachable to the hot air inlet of the portable sauna enclosure, the hot air unit includes a thermostat control.

### CROSS-REFERENCE TO RELATED APPLICATIONS

This application claims the benefit of U.S. Provisional Application No. 60/649,315, filed 2 Feb. 2005.

### FIELD OF THE INVENTION

This invention relates to personal care devices.

More particularly, the present invention relates to saunas.

### BACKGROUND OF THE INVENTION

Sauna systems are usually rather large and require sufficient area/volume within a home, hotel, or other facility to incorporate the moisture, heat, and occasional use. Because of the heat/moisture involved, a special area is generally required that can handle the conditions without deteriorating too rapidly and without interfering with other services in the facility. As understood by those familiar with saunas, this requires a dedicated area/volume, that cannot be used for other purposes and that generally must be specially constructed to hold the heat and moisture while not deteriorating too rapidly. Further, because the area/volume must be dedicated only to the sauna, they are usually rare and inconvenient. That is, the average person cannot afford a sauna in the home or in any convenient location.

It would be highly advantageous, therefore, to remedy the foregoing and other deficiencies inherent in the prior art.

Accordingly, it is an object of the present invention to provide a new and improved portable sauna.

Another object of the invention is to provide a new and improved portable sauna that is relatively inexpensive to provide and operate.

Another object of the invention is to provide a new and improved portable sauna that can be operated virtually anywhere.

Another object of the invention is to provide a new and improved portable sauna that does not require any dedicated permanent area or volume in which to operate.

### SUMMARY OF THE INVENTION

Briefly, to achieve the desired objects of the instant invention in accordance with a preferred embodiment thereof, provided is a portable sauna system including a portable sauna enclosure defining an enclosed body receiving interior volume, the enclosure defining a head opening, two hand openings, and two foot openings. A hot air inlet formed in the portable sauna enclosure is designed to receive a hot air outlet of a hot air supply for communicating hot air from the hot air supply to the body receiving interior volume.

The desired objects and purposes of the present invention are further realized in a preferred embodiment of a portable sauna system in accordance with the invention in which the system includes a portable sauna enclosure defining an enclosed body receiving interior volume. The enclosure is fabricated of a heat resistance and water resistant flexible material defining a head opening, two hand openings, and two foot openings. Elastic constricting elements are attached to the enclosure and encircle each of the head opening, two hand openings, and two foot openings. A divide is provided that extends from the head opening to a point spaced apart from a bottom end for entering a body into the enclosure, opposing sides of the divide include a closure device, such as a zipper or buttons, to close the enclosure about a body. A hot air inlet is formed in the portable sauna enclosure and includes a hot air inlet valve with a biasing element movable between an extended or closed position closing the inlet valve and a depressed or open position allowing warm air to enter the portable sauna enclosure. The hot air inlet valve further includes a diffuser for diverting incoming hot air substantially parallel to an inner surface of the portable sauna enclosure.

### BRIEF DESCRIPTION OF THE DRAWINGS

The foregoing and further and more specific objects and advantages of the instant invention will become readily apparent to those skilled in the art from the following detailed description of a preferred embodiment thereof, taken in conjunction with the drawings in which:

FIG. 1 is a perspective view of a portable sauna system according to the present invention;

FIG. 2 is a perspective view of a portable sauna enclosure according to the present invention;

FIG. 3 is a perspective view of a portion of a portable sauna enclosure illustrating an inlet valve assembly;

FIG. 4 is a top view of the portion of the portable sauna enclosure illustrating the inlet valve assembly of FIG. 3;

FIG. 5 is a front plan view of the portable sauna enclosure according to the present invention;

FIG. 6 is a top elevation view of the portable sauna enclosure; and

FIG. 7 is a side elevation view of the portable sauna enclosure.

### DETAILED DESCRIPTION OF THE DRAWINGS

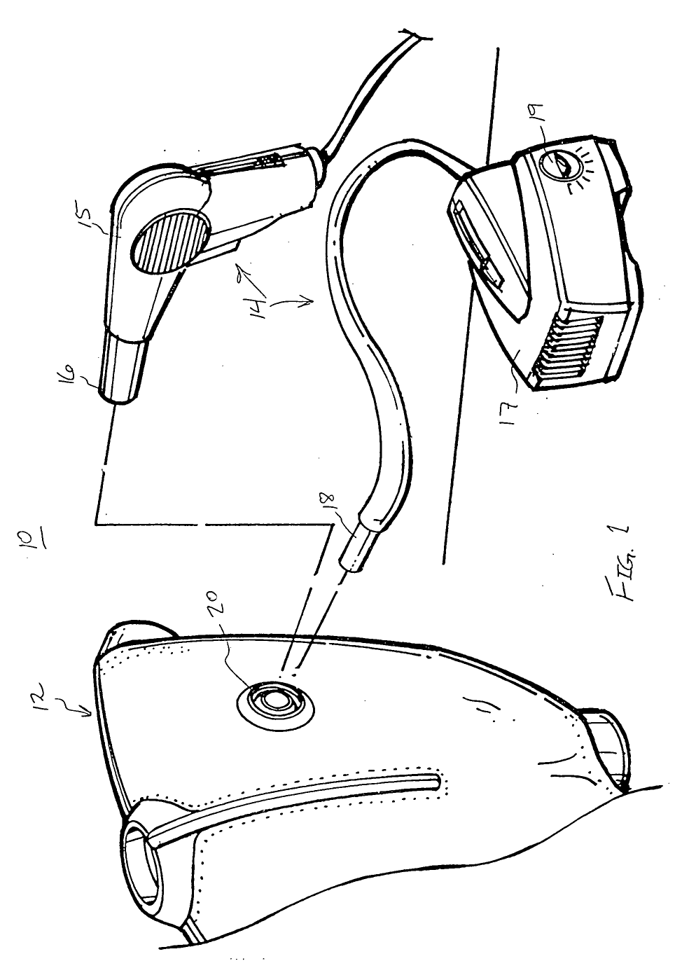

Turning now to the drawings is which like characters indicate corresponding elements throughout the several views, attention is directed to FIG. 1 which illustrates a portable sauna system generally designated 10. System 10 includes a portable sauna enclosure 12 and a hot air supply 14. Hot air supply 14 can be provided in various configurations including a hair dryer type apparatus 15 having a nozzle 16, and a hot air unit 17 having a nozzle 18 or other hot air outlet. Hot air supply 14, such as hot air unit 17, can include a thermostat control 19 for adjusting the temperature of air produced thereby and emitted through nozzle 18. Portable sauna enclosure 12 includes an inlet valve assembly 20 for receiving one of nozzles 16 or 18 therein.

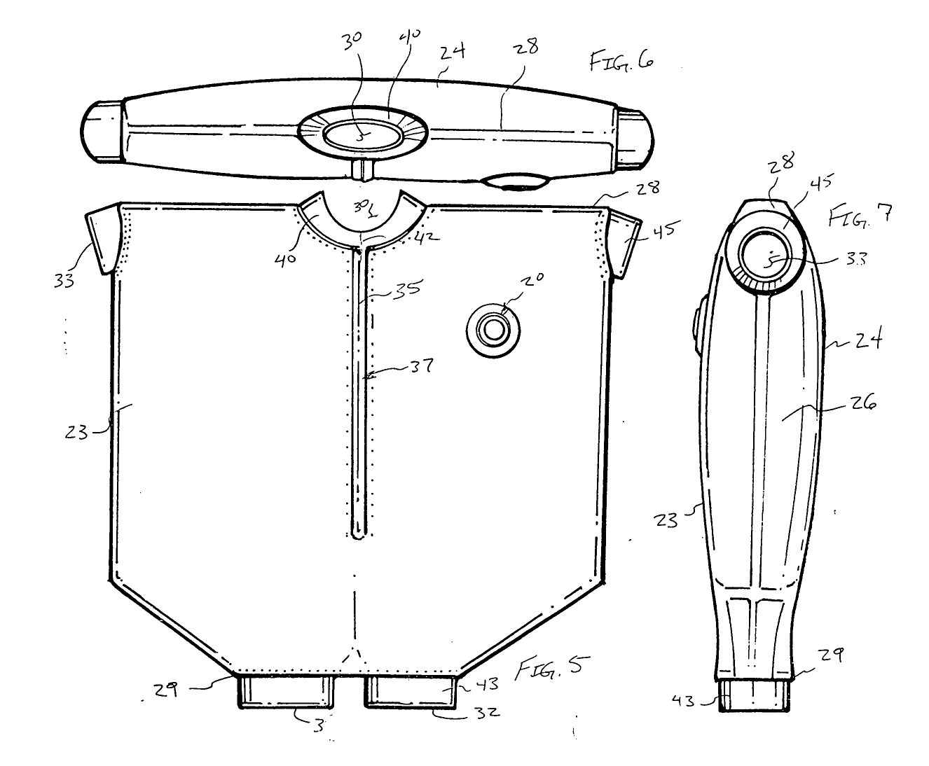

Turning now to FIGS. 2 and 5-7, portable sauna enclosure 12 includes an enlarged body portion 22 defining an interior volume and having a front panel 23, a back panel 24, opposing sides 25 and 26, a top end 28 and a bottom end 29. Body portion 22 includes a head opening 30 centrally located in top end 28, a pair of foot or leg openings 32 formed in bottom end 29, and an arm opening 33 formed in each of opposing sides 25 and 26 proximate top end 28. Front panel 23 has a divide 35 extending from head opening 32 to a point spaced apart from bottom end 29. Divide 35 includes a closure device 37 attached to opposing sides thereof, such as a zipper, buttons, snaps, Velcro® fasteners, and the like. Divide 35 has an open orientation allowing an individual to enter the volume defined by body portion 22, and a close orientation wherein the closure device closes divide 35 and therefore body portion 22 other than the aforementioned openings.

Portable sauna enclosure 12 further includes elastic or constricting elements encircling each of the plurality of openings of body portion 22. In other words, a radially inwardly constricting collar 40 extends from body portion 22 encircling head opening 32. Collar 40 includes a divide 42 aligned with divide 35 and closed by closure device 37. A radially inwardly constricting foot band 43 extends from body portion 22 encircling each foot opening 32. A radially inwardly constricting arm band 45 extends from body portion 22 encircling each arm opening 33. The previously enumerated constricting elements act to substantially seal the interior volume of portable sauna enclosure 12 by gently constricting around a user's extremities. The constriction need not be of sufficient force to cause discomfort or loss of circulation to the user's extremities. It will also be understood, that while body portion 22 is sized to receive the majority of a user's body, including most of the arms and legs, sleeves or legs may be attached to body portion 22 to reduce the volume of body portion 22 while covering substantially the entire body. In this preferred embodiment, portable sauna enclosure 12 is fabricated of a heat resistance and water resistant, preferably flexible material. Portable sauna enclosure 12 can also be sized as a “one size fits all”, or of increased or decreased volume, as desired.

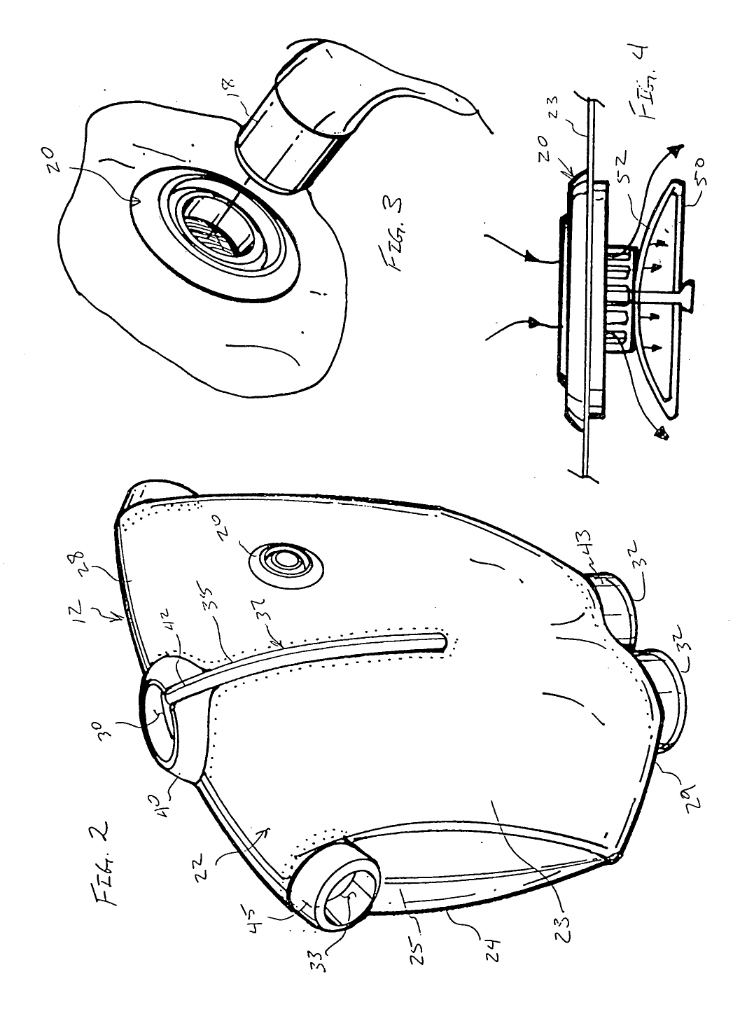

With additional reference to FIGS. 3 and 4, inlet valve 20 is illustrated. Inlet valve 20 is carried by front panel 23, and extends therethrough in communication with the interior volume defined by body portion 22. Inlet valve 20 is designed to receive a nozzle, such as nozzle 18 of hot air unit 17. Inlet valve 20 may consist of a simple opening to which a nozzle is inserted and/or otherwise attached, or as in the present embodiment, can include a diffuser 50 carried in the interior volume substantially parallel to the surface of body portion 22. Diffuser 50 diverts the incoming warm air from being directly applied to an individual within the volume to a direction substantially along an inner surface of portable sauna enclosure 12. Diffuser 50 can include a biasing element 52 movable between and extended or closed position closing inlet valve 20 and a depressed or open position allowing warm air to enter portable sauna enclosure 12. Receipt of a nozzle depresses biasing element 52, opening inlet valve 20.

In operation, an individual opens closure device 37 separating divide 35, enters the interior volume and extends a foot through each of foot openings 32, a hand through each arm opening 33, and a head through head opening 30. Closure device 37 is then closed moving divide 35 to the closed position. A nozzle of a hot air supply 14 is then coupled to inlet valve 20. Hot air supply 14 is activated, supplying hot air through inlet valve 20 into the interior volume to provide a sauna atmosphere.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A portable sauna system comprising:
a portable sauna enclosure defining an enclosed body receiving interior volume, the enclosure defining a head opening, two hand openings, and two foot openings; and
a hot air inlet formed in the portable sauna enclosure designed to receive a hot air outlet of a hot air supply for communicating hot air from the hot air supply to the body receiving interior volume.

2. A portable sauna system as claimed in claim 1 wherein the portable sauna enclosure is fabricated of a heat resistance and water resistant flexible material.

3. A portable sauna system as claimed in claim 2 wherein the portable sauna enclosure includes a divide extending from the head opening to a point spaced apart from a bottom end for entering a body into the enclosure, opposing sides of the divide including a closure device to close the enclosure about a body.

4. A portable sauna system as claimed in claim 3 wherein the closure device includes one of a zipper, buttons, snaps, and Velcro® fasteners.

5. A portable sauna system as claimed in claim 1 wherein the portable sauna enclosure further includes constricting elements encircling each of the head opening, two hand openings, and two foot openings of the portable sauna enclosure.

6. A portable sauna system as claimed in claim 1 wherein the constricting elements are formed of elastic material to substantially seal the interior volume of portable sauna enclosure by gently constricting around a user's extremities.

7. A portable sauna system as claimed in claim 1 wherein the hot air inlet formed in the portable sauna enclosure includes a hot air inlet valve.

8. A portable sauna system as claimed in claim 7 wherein the hot air inlet valve includes a biasing element movable between and extended or closed position closing the inlet valve and a depressed or open position allowing warm air to enter the portable sauna enclosure.

9. A portable sauna system as claimed in claim 7 wherein the hot air inlet valve includes a diffuser for diverting incoming hot air substantially parallel to an inner surface of the portable sauna enclosure.

10. A portable sauna system as claimed in claim 1 further including a hot air unit having a hot air outlet nozzle attached to the hot air inlet of the portable sauna enclosure.

11. A portable sauna system as claimed in claim 10 wherein the hot air unit includes a thermostat control.

12. A portable sauna system comprising:
a portable sauna enclosure defining an enclosed body receiving interior volume, the enclosure defining a head opening, two hand openings, and two foot openings;
a hot air inlet formed in the portable sauna enclosure designed to receive a hot air outlet of a hot air supply for communicating hot air from the hot air supply to the body receiving interior volume; and
a hot air unit having a hot air outlet nozzle attachable to the hot air inlet of the portable sauna enclosure, the hot air unit including a thermostat control.

13. A portable sauna system as claimed in claim 12 wherein the portable sauna enclosure is fabricated of a heat resistance and water resistant flexible material.

14. A portable sauna system as claimed in claim 13 wherein the portable sauna enclosure includes a divide extending from the head opening to a point spaced apart from a bottom end for entering a body into the enclosure, opposing sides of the divide including a closure device to close the enclosure about a body.

15. A portable sauna system as claimed in claim 14 wherein the closure device includes one of a zipper, buttons, snaps, and Velcro® fasteners.

16. A portable sauna system as claimed in claim 15 wherein the portable sauna enclosure further includes constricting elements encircling each of the head opening, two hand openings, and two foot openings of the portable sauna enclosure.

17. A portable sauna system as claimed in claim 16 wherein the constricting elements are formed of elastic material to substantially seal the interior volume of portable sauna enclosure by gently constricting around a user's extremities.

18. A portable sauna system as claimed in claim 17 wherein the hot air inlet formed in the portable sauna enclosure includes a hot air inlet valve including a biasing element movable between and extended or closed position closing the inlet valve and a depressed or open position allowing warm air to enter the portable sauna enclosure, the hot air inlet valve further including a diffuser for diverting incoming hot air substantially parallel to an inner surface of the portable sauna enclosure.

19. A portable sauna system comprising:
a portable sauna enclosure defining an enclosed body receiving interior volume, the enclosure being fabricated of a heat resistance and water resistant flexible material defining a head opening, two hand openings, and two foot openings, elastic constricting elements encircling each of the head opening, two hand openings, and two foot openings of the portable sauna enclosure, and a divide extending from the head opening to a point spaced apart from a bottom end for entering a body into the enclosure, opposing sides of the divide including a closure device to close the enclosure about a body; and
a hot air inlet formed in the portable sauna enclosure and including a hot air inlet valve including a biasing element movable between an extended or closed position closing the inlet valve and a depressed or open position allowing warm air to enter the portable sauna enclosure, the hot air inlet valve further including a diffuser for diverting incoming hot air substantially parallel to an inner surface of the portable sauna enclosure.

20. A portable sauna system as claimed in claim 19 further including a hot air supply with a hot air outlet nozzle connectable to the hot air inlet for communicating hot air from the hot air supply to the body receiving interior volume of the portable sauna enclosure.
